(19) United States
(12) Patent Application Publication
(10) Pub. No.: US 2021/0003539 A1
(43) Pub. Date: Jan. 7, 2021

(54) An improved thermal modulator

(71) Applicant: Dani Analitica S.r.l., Cologno Monzese (Milano) (IT)

(72) Inventors: William W. Carson, Cologno Monzese (Milano) (IT); Alberto Crotti, Cologno Monzese (Milano) (IT); Massimiliano Saini, Cologno Monzese (Milano)it (IT); Roberto Taschini, Cologno Monzese (Milano) (IT)

(21) Appl. No.: 15/733,589

(22) PCT Filed: Mar. 19, 2019
(86) PCT No.: PCT/IB2019/052211

§ 371 Date: Sep. 7, 2020

(30) Foreign Application Priority Data
Mar. 20, 2018 (IT) 102018000003787

(51) Int. Cl. G01N 30/30

(52) U.S. Cl. CPC G01N 30/30; G01N 2030/025; G01N 2030/3053

(57) ABSTRACT

A thermal modulator for gas chromatography includes an analytical capillary to be traversed by analytes and that is interposed between two gas chromatographic columns; a cooling system having a cold zone, a support element associated with the cold zone and supporting a portion of the analytical capillary at a corresponding or slightly higher temperature than the cold zone, so as to define a trapping portion of the analytes; a control system, which selectively controls the emission of pulsed current to electrically conductive elements associated with the analytical capillary to heat the trapping portion and cause the release or desorption of previously immobilized analytes; and a heating system of a portion of the analytical capillary, positioned outside of the support element and upstream of the support element, so as to generate a rapid expansion of the gas contained in the portion and facilitate the advancement of the released or desorbed analytes.

The present invention relates to an improved thermal modulator for gas chromatography.

Modulators are known that are used to maximize the effectiveness of the separation process both in traditional gas chromatographs, refocusing the sample bands, and in two-dimensional gas chromatography or GC×GC (comprehensive GC×GC), blocking the effluent exiting from a first column and then separating it into small portions which are entered at regular time intervals in a second column typically but not exclusively with separation properties different from the first.

Gas chromatography is widely used in separation analytical techniques in various sectors, such as the environmental one, the petrochemical one, the pharmaceutical one or even the one of aromas and perfumes.

A gas chromatographic system is traditionally composed of a gas chromatograph, essentially comprising an injector, used to introduce the sample to be analyzed, an oven or in any case a heater element and an analog or digital detector of different types, capable of recording through an electrical signal the traces of the effluent and separated substances. The separation takes place by gas chromatography within a capillary column, placed in the gas chromatograph oven and connected to the injector and to the latter's detector. As said, in its interior, the mixture of substances are made to flow through a carrier gas, and are separated by interacting each in a different way with the stationary phase of the column. The stationary phase is constituted by a film of material, generally polymeric, which covers the inner wall of the capillary tube constituting the column.

Despite the great progress made from the point of view of the instrumentation and from the point of view of the search for new stationary phases capable of separating critical groups of compounds, traditional gas chromatography is not sufficient to resolve analytically in a complete manner the so-called complex mixtures (samples that contain hundreds of substances to be separated), nor even simpler samples from the point of view of the number of constituents but presenting unresolvable groups of great analytical interest. For this reason, in particular in the last decade a technique called in the literature GC×GC or two-dimensional gas chromatography has been developed, which uses two gas chromatographic systems connected together through a modulator.

In a preferred embodiment, the first system uses an injector, a column of conventional dimensions (typically with an internal diameter of 0.25-0.32 mm and a length of 30 m), while the second uses a column that allows a separation process extremely fast compared to the first (for example of variable length between 70 cm and 2 m with internal diameters from 0.1 to 0.2 mm), which is then connected to its output with the detector.

The two columns are placed in the same oven or in different ovens and are interfaced with each other through a modulator, which is the object of the present invention, and which allows the output of the first column to be connected in series to the input of the second column. In essence, the modulator plays a fundamental role in that it blocks the eluent compounds from the first column and reintroduces small aliquots of these eluent compounds in a rhythmic manner in the second column, in order to make a separation by applying different separation principles and thus creating a second chromatographic dimension. In this way, the molecules not completely resolved in the first dimension are completely resolved in the second dimension and therefore identifiable by the analyst.

In recent years, different modulators have already been proposed and developed, but the most optimized and performing types are those with a thermal effect. In particular, the first thermal effect modulators involved the use of a local and floating heating element. Because of their low efficiency and complexity they have been replaced by thermal modulators with cooling by controlled flushing of gases strongly cooled by cryogenic fluids, such as CO₂ or nitrogen.

At present, the thermal modulator with cryogenic liquid nitrogen cooling appears to be the best apparatus that can be used for modulation in bidimensional gas chromatography, both in terms of the range of separable molecules (both ultra-volatile and semi-volatile), and in terms of separation capacity (width of the chromatographic band in the second dimension).

In this modulator, a jet of gas, pre-cooled with liquid nitrogen, freezes a short section of the gas chromatographic column, thus immobilizing the analytes by condensing them on its inner wall. The analytes are then remobilized by means of a jet of hot gas, typically nitrogen, at an adjustable temperature, typically 250-400° C., for an adjustable time, typically 100-1000 ms. The flows of cold and hot gas are related to each other and not modulable because they derive from the same pneumatic circuit at constant pressure.

Laboratory tests have demonstrated the great efficiency of this modulator with chromatographic bands of peaks from the second column having a width up to 200 ms at the base.

However, the mass of cooling gas used (typically nitrogen gas) is considerably higher than the size of the capillary to be cooled and, therefore, much of its cooling capacity is not used to cool the capillary but is dispersed in the gas chromatograph oven. Furthermore, this cold gas flow disrupts the thermoregulation in the gas chromatograph oven making it difficult to reach and stabilize the oven temperature set point. In essence, the cold gas interferes with the oven temperature sensor, thus considerably altering the thermal state of the oven.

The use of this type of modulators therefore has the following drawbacks:
liquid nitrogen is produced in plants far from the analysis laboratory by cooling with large industrial adiabatic plants and is closed under pressure in large Dewar vessels that are particularly difficult to handle and transport,
during transport, part of the nitrogen passes to the gaseous state, thus increasing the pressure in the Dewar vessels and is also dispersed in the atmosphere through the control valve,
once it has arrived in the laboratory it must be used continuously, otherwise it disperses into the environment,
as previously mentioned, during use to cool the modulator, only part of the effective cooling capacity of the cold gas is used to cryofocalize the analytes, while most are dispersed in the furnace.

In essence, the cryogenic cooling carried out by convection by means of cooled nitrogen, besides being inefficient, is particularly expensive.

Furthermore, in cryogenic cooling using liquid nitrogen, the minimum temperature for trapping/immobilizing the analytes corresponds to the minimum achievable temperature for the liquid nitrogen (i.e. about −196° C.), however the temperature actually reached in the trapping/immobilization zone (also called “trap”) is much higher due to the heat absorbed by the nitrogen during its travel.

Alternatively, modulators are available on the market which allow the use of less expensive cryogenic gases (for example CO₂); however, these do not solve the management and transport problems relating to gas containment vessels; moreover, they are not suitable for modulating ultra-volatile molecules since they do not allow to reach low cryogenic temperatures as in the case of nitrogen.

Again, instead of thermal modulators, fluidic type modulators have been proposed. In particular, these modulators require high column flows, which are incompatible with mass spectrometry (which is one of the most commonly used detectors in this application), unless high split inputs are used, and in any case they require a high consumption of gas. Moreover, the performances are not comparable with those achievable with thermal modulators, in terms of separation efficiency in the second column (for example, with these modulators chromatographic peaks with a width of about 750-1000 ms are obtained, while with thermal modulators much narrower peaks are achieved, i.e. with a width of about 200 ms).

Furthermore, in a modulator, in addition to the minimum achievable temperature, another critical parameter is the speed at which this temperature is reached. In fact, in the thermal modulator, the analytes are focused, then blocked, by condensation or freezing inside a capillary tube, which connects the first and second columns. It is necessary to activate for a short period (hundreds of milliseconds) a heater to then allow the remobilization of analytes. However, when the heater is deactivated again, it is essential that the temperature of the capillary returns as quickly as possible to the initial conditions prior to the activation of the heater in order to allow instantaneous cryofocalization again, and therefore the subsequent blocking of the analytes in the capillary.

In particular, in currently known modulators, the speed for trapping and releasing the analytes is not high enough. More in detail, the low speed of opening/closing of the trap depends, in fact, on the type of solution used for gas convection (both for heating and for cooling). In modulators with single-stage trap, due to the long-time interval necessary to close again (by cooling) the trap itself after having released/opened it (by heating), a sample leakage occurs through the trap itself; moreover, the long-time interval required for the opening of the trap and the slow increase in temperature of the trap itself causes an extension and differentiation of the peak band (“peak band”). In modulators with two-stage trap, the alternate activation/opening of the two stages of the trap reduces the problem of leakage, however the pressure impulse generated when the opening occurs at the first stage can disturb the second chromatographic phase and the flow rate towards the detector, thus causing significant changes in the detector signal as a final result.

Furthermore, the currently known modulators also have the following disadvantages:
the temperatures for the trapping/immobilization of the analytes cannot be easily defined and modified; in fact, in general, the trapping/immobilization temperature is set at a value slightly higher than the temperature of the transition state of the cryogenic fluid (liquid/gas),
the temperatures for the release of the analytes cannot be easily defined and modified,
the temperatures actually reached by the convection gas (and by the capillary) both in the cooling and heating phases are difficult to detect and evaluate.

US2011/088452 describes a thermal micro-modulator in which the cooling device acts on a support frame and on a sequence of connecting sections crossed by the analytical capillary. In US2011/088452 all the heaters provided in the micro-modulator act inside the supporting frame or of said connecting sections in contact with the cooling device.

WO2017/173447 describes a thermal modulator in which the capillary passes through a thermal buffer and a heat exchange block which are associated with a cold zone, which in turn is in contact with the cooling device. In WO2017/173447 all the heaters are positioned inside the trapping portion which is defined by the capillary portion that passes through the thermal buffer and the heat exchange block associated with the cold zone.

The object of the invention is to propose an improved gas chromatography thermal modulator which overcomes the drawbacks of traditional solutions.

Another object of the invention is to propose a modulator in which the range of trapping/immobilization temperature of the analytes is particularly wide.

Another object of the invention is to propose a modulator in which the range of temperature for the release of the analytes is particularly wide.

Another object of the invention is to propose a modulator in which the rate of release and/or trapping/immobilization of the analytes is particularly high.

Another object of the invention is to propose a modulator which allows a high chromatographic resolution.

Another object of the invention is to propose a modulator that generates peaks of particularly limited width and particularly high height at the output, thus improving the sensitivity of the detection system.

Another object of the invention is to propose a modulator in which the range of the modulation frequency is particularly high.

Another object of the invention is to provide a modulator which can be obtained in a simple, rapid manner and with low production costs.

Another object of the invention is to propose a modulator in which the thermal modulation is particularly effective.

Another object of the invention is to propose a modulator which allows to increase the effective lifetime of the capillary provided in the modulator itself.

Another object of the invention is to propose a modulator which presents a particularly efficient cooling from an energy point of view.

Another object of the invention is to provide a modulator whose use is simple and inexpensive.

Another object of the invention is to propose a modulator with an alternative and/or improved characterization, both in constructive and functional terms, with respect to the traditional ones.

Another object of the invention is to provide a modulator that can be produced on a large scale and that can be used substantially with all gas chromatographs, both for applications in one-dimensional and two-dimensional gas chromatography, including those combined with low and high acquisition frequency mass spectrometers.

All these aims, both individually and in any combination thereof, as well as other objects which will be apparent from the following description, are achieved, according to the invention, with an improved modulator with the characteristics indicated in claim 1.

The present invention is further clarified below with reference to the attached tables of drawings, in which:

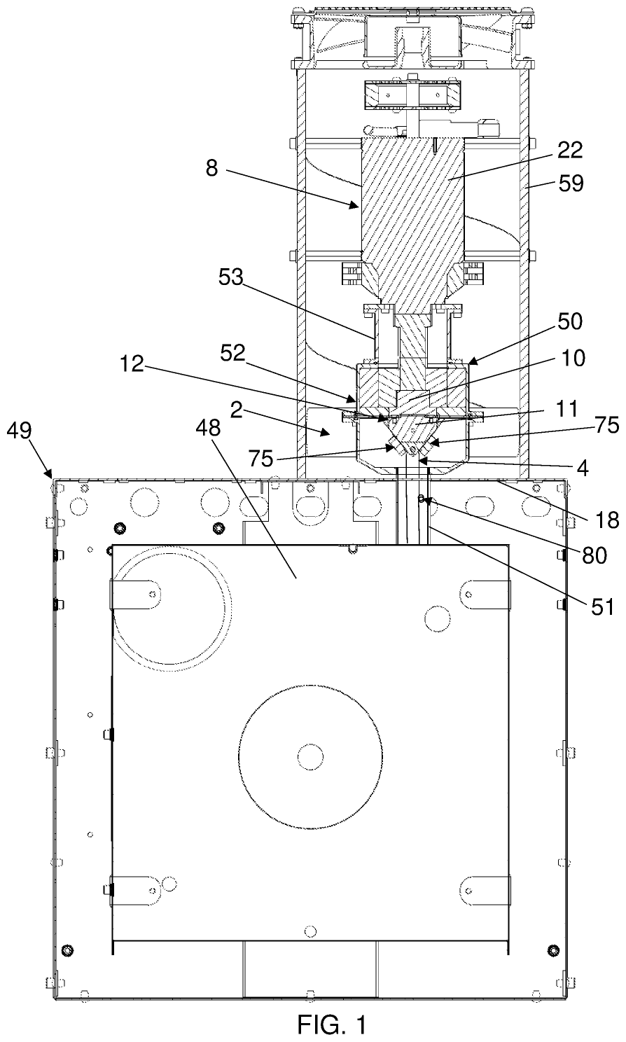

FIG. 1 shows according to a vertical section a gas chromatograph with an improved thermal modulator according to the invention,

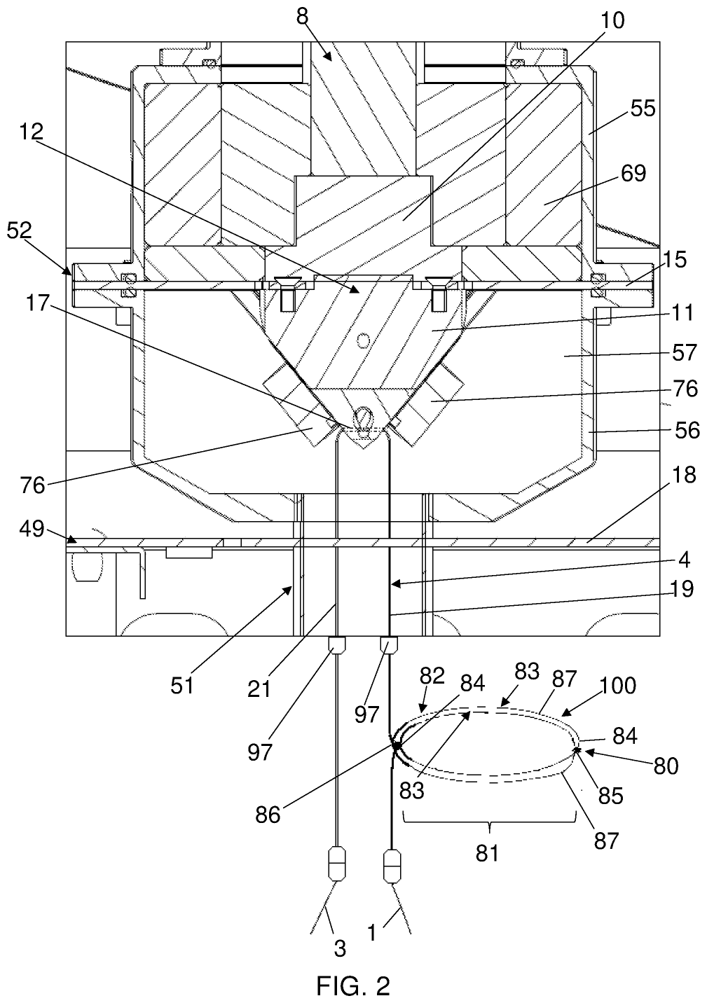

FIG. 2 shows an enlarged detail of FIG. 2,

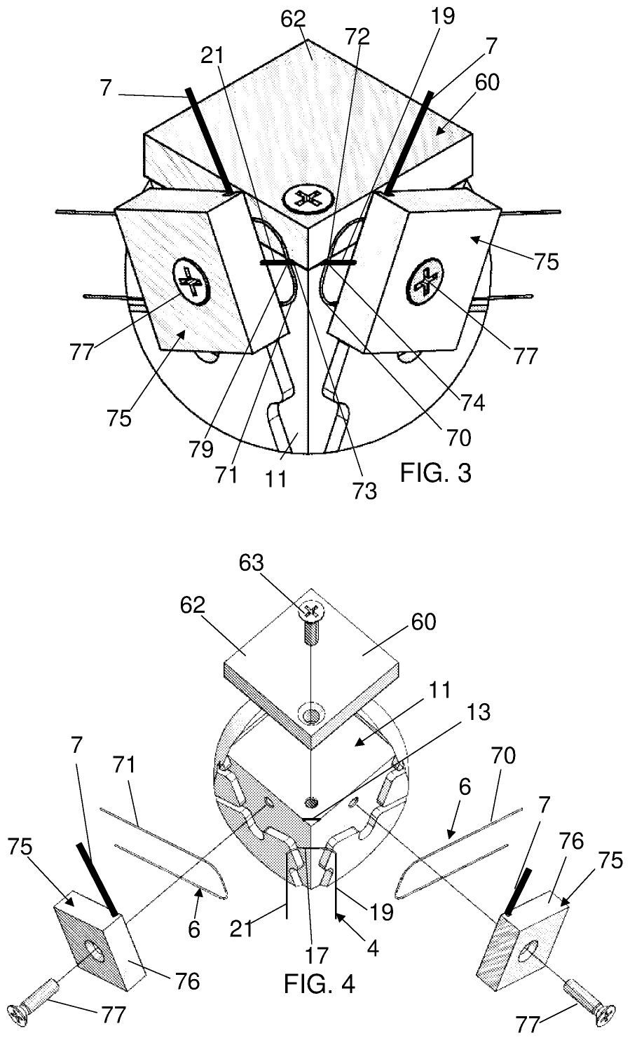

FIG. 3 shows in perspective view an internal unit of the modulator,

FIG. 4 shows in an exploded perspective view the internal unit of FIG. 3

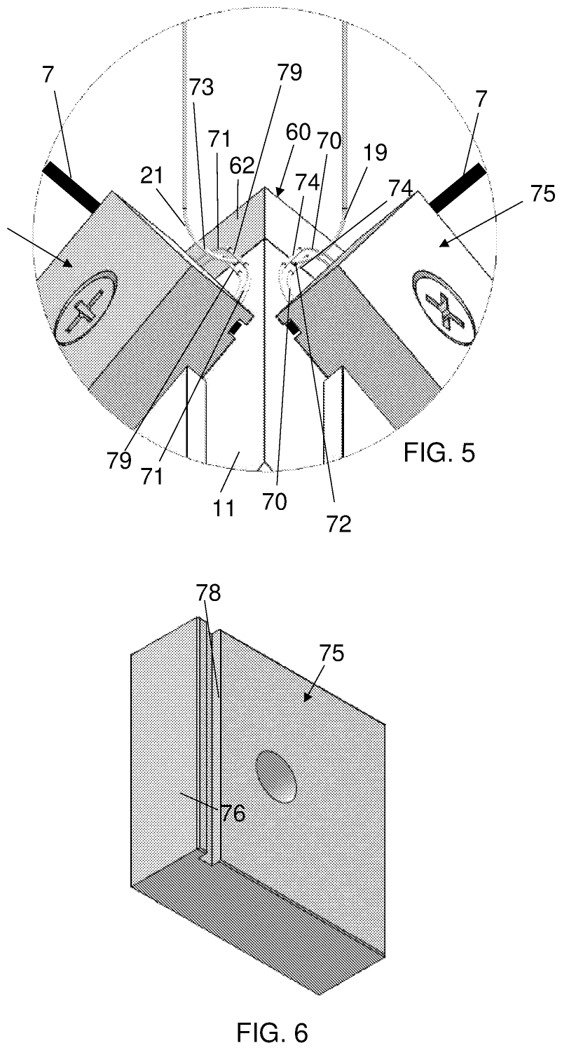

FIG. 5 shows in a perspective view a different embodiment of the internal unit of FIG. 3

FIG. 6 shows in perspective view a component of the internal unit of FIG. 3, and

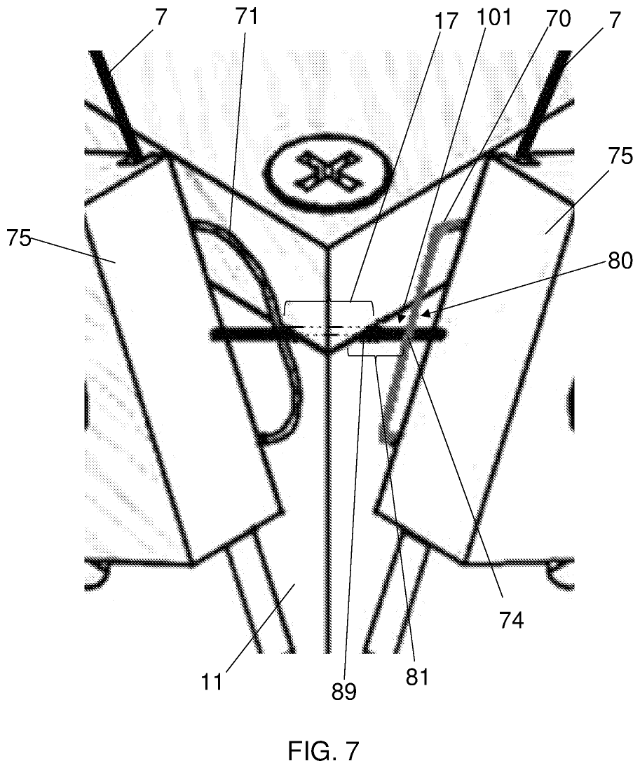

FIG. 7 shows in perspective view an enlarged detail of a different embodiment of the internal unit of the modulator.

As can be seen from the figures, the modulator 2 according to the invention comprises an analytical capillary 4 for the connection between two gas chromatographic columns 1, 3 which, preferably, have different separation properties.

Conveniently, the analytical capillary 4 can be physically constituted by a separate section of column with respect to the two columns 1 and 3, or, alternatively, it can be constituted by the terminal portion of the first column 1 or by the initial section of the second column 3.

Suitably, the analytical capillary 4 is made of metal, preferably of nickel alloys (for example Inconel 600, Inconel 625 or others) or steel (for example SS316 and others).

Advantageously, the internal walls of the analytical capillary 4 are suitably inert from the chemical point of view. Advantageously, the internal diameter of the analytical capillary 4 is about 50-250 μm, preferably 100 μm.

Advantageously, the wall thickness of the analytical capillary 4 is 50-200 μm, preferably 75 μm.

The modulator 2 also comprises a cooling system 8 which preferably consists of a Stirling cryocooler 8, that is a device that implements and uses the reverse Stirling cycle. However, alternatively, the cooling system may comprise Peltier cells, possibly also in series, or other traditional cooling means.

The cooling system 8 comprises a cold zone 10 which is associated with an element 11, thus defining a cold group 12, which is in contact with a portion 17 of the analytical capillary 4 so as to cause cooling by conduction of the latter. In particular, this portion of the analytical capillary 4 is the portion in which, following the attainment of a certain particularly low temperature (also called “trapping temperature”), the analytes are trapped/immobilized on the internal walls of the portion itself and, therefore, this portion is hereinafter referred to as the “trapping portion”. Preferably, the trapping portion 17 comprises the portion of the analytical capillary 4 which is substantially in contact with the cold group 12 and which is cooled by conduction from the latter.

In particular, the element 11 is fixed to the cold zone 10 of the cooling system 8 so that said element 11 has substantially the same temperature as said cold zone 10. Advantageously, this is achieved by planar coupling between the surfaces of said element 11 and of said cold zone 10, preferably favoured by the interposition of a layer 15 of paste which allows thermal conduction. Furthermore, this is achieved by the presence, substantially around the entire cold group 12, of thermally insulating materials—respectively 69 for the cold zone 10 and 57 for the element 11—so that the heat absorption by the whole cold group 12 is as small as possible, thus allowing the cooling system 8 to operate efficiently and therefore to reach the lowest operating temperatures.

Conveniently, the element 11 is made of a material having a high thermal conductivity and electrically insulating at least at its surface. In particular, the element 11 can have a substantially pyramidal shape or other suitable shape, also discoidal.

Conveniently, the element 11 comprises a seat 13 inside which the trapping portion 17 of the analytical capillary 4 is preferably housed—preferably—the seat 13 is constituted by a through cavity, preferably cylindrical, formed in the body of the element 11 or may also be constituted by a surface groove.

Conveniently, the portion of the analytical capillary 4 which is in contact and/or passes through the element 11 defines the trapping portion 17 and, in particular, in this portion, the analytes, leaving the first column 1, are immobilized by reaching a cryogenic temperature, generated by the cold zone 10 of the cooling system 8.

Conveniently, the analytical capillary 4 is constrained/locked to the element 11 by clamping means 60. Preferably, these clamping means 60 comprise a body 62, which is constrained by traditional fastening means 63 (for example screws) to the element 11 so as to maintain the portion 17 of the capillary 4 in contact with said element.

Advantageously, the element 11 has a geometry such as to define a mechanical interface and an optimum heat exchange between the cold zone 10 of the cooling system and the portion 17 of the analytical capillary 4.

Advantageously, the element 11 has a configuration suitable for supporting the analytical capillary 4 so as to fix and maintain the trapping portion 17 in contact with the cold group 12, so that this portion is substantially at the same temperature as the cold zone 10.

Advantageously, the element 11 is made of metallic material which has excellent thermal conductivity, but suitably electrically isolated at least on the surface. Preferably, the element 11 is made for example of aluminium or copper, or their alloys with appropriate surface insulation. Advantageously, the electrical insulation is obtained by surface treatments (anodization) or by applying insulating films with good thermal conductivity characteristics.

As mentioned, the analytical capillary 4 comprises a trapping portion 17, which is preferably entirely housed and crosses/is in contact with the seat 13 of the element 11, and two portions 19 and 21 which are external to the seat 13 of the element 11 and are located upstream and downstream of said portion 17 respectively. Preferably, the portion 17 defines the so-called “trapping portion of the analytical capillary”, while the upstream portion 19 defines the so-called “inlet portion” and, finally, the portion 21 downstream defines the so-called “outlet portion”. In other words, the portions 19 and/or 21 of the analytical capillary 4 are external to the support element 11 (and therefore are not in contact with the latter) and are respectively upstream and downstream of the portion 17 of the analytical capillary 4 which passes through and/or is in contact with said support element 11.

Preferably, the trapping portion 17 of the analytical capillary 4, i.e. the portion which is housed inside the seat 13 of the element 11, has a substantially rectilinear development, while the inlet 19 and outlet 21 portions of said analytical capillary 4 have initially a substantially curved development and then continue with a substantially straight-line development.

The modulator 2 also comprises electrically conductive elements 70, 71 which are associated with the analytical capillary 4 and which are connected to an electrical energy source so as to transfer the electric current to said capillary 4 so as to cause heating of the capillary section which defines the trapping portion 17 and, in particular, for heating said portion 17 from the cryogenic temperature to a higher temperature (substantially corresponding to the boiling point of the analytes to be analyzed), thus causing the desorption of the analytes, which are thus released so as to exit the trapping portion 17 and move towards the entrance of the second column 3.

Conveniently, the cold zone 10 of the cooling system 8 cools the element 11 and then by conduction also the portion 17 of the analytical capillary 4, when said portion 17 does not receive electric current from the electrically conductive elements 70, 71. Instead, when the portion 17 receives pulsed currents which are particularly high from the electrically conductive elements 70, 71; the heating effect of the said portion 17 is so fast and adiabatic (i.e. it does not give off heat to the outside) to prevail over the aforesaid cooling.

The current transmission to the electrically conductive elements 70, 71 is managed by the control unit (not shown) of the modulator 2 which appropriately controls their activation and deactivation by sending pulsed current—preferably of substantially square wave current pulses—generated by a suitable electronic system, preferably by charging and discharging capacitors. Preferably this pulsed current sent to the electrically conductive elements 70, 71 is about 10-200 A, preferably about 80 A. Suitably, the effective duration of the pulsed current modulation is 0.1 ms-10 ms, preferably 0.5 ms; suitably, the frequency of the pulsed current is about 0.03-10 Hz, preferably about 0.1-1 Hz.

Conveniently, these current pulses are sent to the input and returned to the output by means of suitable conducting elements 7, preferably cables or copper pipes, which are associated with the electrically conductive elements 70, 71 by means of a stable, preferably mechanical, constraint.

In particular, the electrically conductive elements comprise at least a first electrically conductive element 70 for the input (or output) of the current and at least a second electrically conductive element 71 for the output (or input) of the current.

Preferably, the heating means are defined by the same portion of analytical capillary 4—which is made of electrically conductive material—which is interposed between said at least one first electrically conductive element 70 and said at least one second electrically conductive element 71.

Preferably, said first electrically conductive element 70 and said electrically conductive element 71 are associated, preferably by microwelding, in correspondence respectively with an inlet section 72 and with an outlet section 73 of the portion 17 of the analytical capillary 4 which passes through the seat 13 of the element 11. More in detail, at least one first electrically conductive element 70 is associated directly, in correspondence with a contact area 74, with an inlet section 72 to said portion 17 of the analytical capillary 4 while at least one second electrically conductive element 71 it is directly associated, in correspondence with a contact area 79, to an outlet section 73 from the portion 17 of the analytical capillary 4.

Conveniently, the inlet 72 and outlet 73 section correspond respectively to the inlet and outlet ends of the analytical capillary 4 inside the element 11, or are two portions which, although being external with respect to the trapping portion 17, are placed respectively. upstream and downstream of said start and exit ends.

Advantageously, as shown in FIG. 5, two first electrically conductive elements 70 can be provided which are associated with the inlet section 72 of the analytical capillary 4 in correspondence of two respective contact areas 74. Correspondingly, two second electrically conductive elements 71 can be provided. which are associated with the outlet section 73 of the analytical capillary 4 in correspondence of two respective contact areas 79.

Conveniently, the conductive elements 7 are in contact with the electrically conductive elements 70 and 71 so as to allow the passage of current from the first to the second. In particular, for this purpose means 75 are provided for constraining the electrically conductive elements 70, 71 to the conductive elements 7 and, preferably, for constraining both to the element 11.

Advantageously, these constraining means 75 comprise at least two plates 76, each of which is compressed, by means of traditional fixing means 77 (for example of the screws), to the element 11 so that the electrically conductive element 70 or 71 and the respective conductive element 7 between the latter and the corresponding plate 76 are blocked and maintained in mutual contact. Conveniently, the latter can be incorporated in the plate 76 so that a surface portion of the conductive elements 7 can come into contact with the electrically conductive elements 70 and 71 once the plate is fixed to the element 11. Preferably, the conductive elements 7 are housed within corresponding surface grooves 78 formed on the surfaces of the plates 76.

Preferably, the electrically conductive elements 70 and 71 are made of metallic material. Advantageously, the electrically conductive elements 70 and 71 are filiform and, preferably, consist of metal capillaries of the same type used for the analytical capillary 4. Advantageously, the electrically conductive elements 70 and 71 comprise capillaries made of metal, preferably of nickel alloys (e.g. Inconel 600, Inconel 625 or others) or steel (e.g. SS316 and others). Advantageously, the internal diameter of said capillaries is about 50-250 μm, preferably about 100 μm. Advantageously, the wall thickness of said capillaries is about 50-200 μm, preferably about 75 μm.

Preferably, the electrically conductive elements 70 and 71 are microwelded on at least one inlet section 72 and at least one outlet section 73 with respect to the trapping portion 17 of the analytical capillary 4. Advantageously, the electrically conductive elements 70 and 71 are in contact with the analytical capillary 4 at the beginning (i.e. of the inlet end of the capillary 4 in the element 11) and of the end (i.e. of the outlet end of the capillary 4 from the element 11) of the trapping portion 17 of the analytical capillary 4.

Conveniently, the current pulse arriving by the inlet conductive element 7 passes to the first electrically conductive element 70 and from there passes to the trapping portion 17 of the analytical capillary 4, thus causing the heating of the latter and therefore of the condensates compounds and/or gases contained therein; subsequently, after passing through the trapping portion 17 of the analytical capillary 4, the current passes to the electrically conductive element at the outlet 71 and from there to the outlet conductive element 7 to be grounded. Conveniently, the current path can also be in the opposite direction, then enter the portion 17 of the analytical capillary 4 through the second electrically conductive element 71 and exit from the portion 17 through the first electrically conductive element 70.

Advantageously, the control unit is also configured to send to the electrically conductive elements 70 and 71 a current which causes a substantially continuous (i.e. stable in time) heating of the portion 19 and/or 21 of the analytical capillary 4 which are external to the support element 11 and are respectively upstream and downstream of the portion 17 of the analytical capillary 4 which passes through and is in contact with said support element 11. Basically, the control unit is also configured to send to the electrically conductive elements 70 and 71 a current which causes a substantially continuous heating (i.e. stable over time) of the inlet portions 19 and/or outlet portions 21 of the analytical capillary 4 and, possibly, also of the trapping portion 17.

Conveniently, the current sent to the electrically conductive elements 70 and 71 in order to cause the aforementioned continuous heating is a particularly low direct current (for example of the order of 0.1-3 A, preferably of 1 A, for each branch) or is an alternating current of a frequency greater than about 5 Hz, preferably greater than about 10 Hz and, even more preferably, greater than about 100 Hz. Conveniently, this current, apt to cause a substantially continuous heating, is sent to the electrically conductive elements 70 and 71 and is transferred—at the contact areas 74, 79 of the electrically conductive elements 70 and 71 with the analytical capillary 4—to the inlet 19 and outlet 21 portions of the analytical capillary 4 and, possibly, also to the trapping portion 17. Conveniently, this current sent to the electrically conductive elements 70 and 71 and capable of causing a substantially continuous heating is a current intended to maintain the inlet 19 and outlet 21 portions at a higher temperature (hotter) than the cryogenic immobilization temperature provided in the trapping portion 17, preferably for maintaining said portions at a temperature no lower than that of the thermostated chamber of the gas chromatograph.

Conveniently, two corresponding electrical connections 97 are provided at the inlet 19 and outlet 21 portions for the outlet of the current which has passed through said portions. Preferably, these electrical connections 97 are located inside the thermostated chamber 48 of the gas chromatograph 49.

Therefore, suitably, the current capable of causing a substantially continuous heating is sent both to the first 70 and to the second electrically conductive element 71 and—by means of the respective contact areas 74, 79 of these means with the inlet 72 and of the outlet 73 section of the analytical capillary 4—the current arrives in the inlet 19 and in the outlet 21 portion respectively. Appropriately, the current thus sent passes through said portions 19 and 21 of the analytical capillary 4 to then exit through the respective electrical connections.

Advantageously, the sending of a current capable of causing a substantially continuous heating in the inlet portions 19 and in the outlet portions 21 allows the temperature in said portions to be controlled/adjusted appropriately in order to prevent the cold group 12 from excessively cooling the portions 19 and 21, causing for example a trapping/immobilization of the analytes also in areas external with respect to the portion 17. In this way, the analytes are allowed to suitably cross the analytical capillary 4 thus avoiding that the same analytes are immobilized/focused before reaching portion 17 or are refocused/re-mobilized again after passing through portion 17 (i.e. after being released during and through the heating/desorption cycle).

Advantageously, the transmission also to the trapping portion 17, by means of the electrically conductive elements 70 and 71, of a current apt to cause a substantially continuous heating thereof, allows to regulate and modify the trapping temperature defined by the cold zone 10 and this in the end to improve the focus and the focus position of the analytes.

Advantageously, the control unit is configured to control the electronic system and/or the electric power generator so that when the sending of a pulsed current to the electrically conductive elements 70 or 71 is activated to heat the trapping portion 17 in order to cause the release/desorption of the immobilized analytes in the same portion, the transmission to said electrically conductive elements 70 and 71 of the current suitable for causing a substantially continuous heating is interrupted and vice versa.

Advantageously, the modulator 2 also comprises means 80 for causing the heating, preferably localized and substantially instantaneous, of a portion 81 of the analytical capillary 4, and therefore of the gas present in said portion, so as to cause an expansion of said gas along said capillary. In particular, considering that the capillary has a constant section, the expansion of the gas contained in the capillary section 4 thus heated takes place along the longitudinal development direction of the capillary itself.

Conveniently, said portion 81 which is heated is defined externally and upstream of the portion 17 of said capillary which passes through and/or is in contact with said support element 11 (i.e. of the trapping portion 17) so that the expansion of the gas causes a thrust effect directed towards said portion 17.

Conveniently, the heating of the portion 81 positioned externally and upstream of the trapping portion 17 is obtained by sending a current pulse to said section.

Advantageously, in a first embodiment, said means 80 for causing the heating of a portion 81 of the analytical capillary defined upstream of the trapping portion 17 comprise a first configuration 100 in which the same analytical capillary 4 has a folded portion 82 so as to define one or more windings 83, each of which defines a closed shape with two opposite sections 84 facing each other.

Preferably, each winding 83 substantially defines a circumferential path of the capillary itself. Preferably, the analytical capillary 4 is wound so as to define a helical path with at least one turn. Conveniently, at the opposite sections 84 of each winding 83 of the analytical capillary 4, first electrical contacts 85 and second electrical contacts 86 are applied respectively. In particular, the first electrical contacts 85 are provided for sending current to the capillary thus folded, while the second electrical contacts 86 are provided for grounding the current sent. Suitably the current can flow also in the opposite direction, then entering the windings 83 of the analytical capillary 4 through the second electrical contacts 86 and exiting from the windings 83 themselves through the first electrical contacts 85. Preferably, the first 85 and second 86 electrical contacts are applied in diametrically opposed positions along each winding 83 of the capillary 4. Suitably, the branches 87 of the capillary 4 interposed between the first 85 and the second 86 electrical contacts, and opposed to each other, have substantially the same length so as to balance the currents passing through these branches.

Conveniently, in an embodiment not shown here, the portion 81 can also be a rectilinear segment interposed and defined between the first 85 and second 86 electrical contacts.

Conveniently, said means 80 are managed by the control unit of the modulator 2 which appropriately controls their activation and deactivation by sending appropriate current pulses generated by an electronic system, preferably by charging and discharging capacitors. In particular, the control unit controls the transmission to the first electrical contacts 85 of pulsed current—preferably of substantially square-wave current pulses—of substantially constant intensity, preferably equal to 10-100 A, preferably of 50 A; in particular, suitably, the effective duration of these current pulses is extremely reduced, of the order of 0.1-10 ms, preferably of 1 ms; suitably, the frequency of the pulsed current is about 0.03-10 Hz, preferably about 0.1-1 Hz.

Conveniently, the fact that the current sent to the portion 81 of the analytical capillary 4 is particularly intense and of short duration allows to avoid the energy dispersion towards the outside and causes a localized heating of said portion and, in particular, causes the heating of the windings 83 of the capillary itself. More in detail, this heating of the portion 81 of the analytical capillary 4 causes a corresponding increase in the temperature of the gas contained within this folded portion and therefore a corresponding increase in its volume. In particular, considering that the expansion of the gas is prevented in the radial direction by the inner walls of the capillary, this expansion can actually be achieved just along the longitudinal development direction of the capillary itself, thus causing a linear movement/advancement of the gas upstream and downstream with respect to said folded and heated portion.

Conveniently, in order to increase the linear movement/advancement of the gas caused by the means 80, it is possible to act on the number of windings 83 and on the geometry of these windings, as well as on the intensity and duration of the current pulse sent.

Advantageously, this linear expansion of the gas causes a thrust of the analytes which are inside the trapping portion 17, thus favoring their advancement towards the outlet portion 21 following the release/desorption caused by the heating of said portion 17 obtained by means of the current sent by the electrically conductive elements 70 or 71.

Advantageously, the control unit is configured so that the sending of a pulsed current to the electrically conductive elements 70 or 71—to heat the trapping portion 17 of the capillary 4, so as to cause the release/desorption of the immobilized analytes in said portion—either carried out simultaneously or with a slight delay, with respect to the sending of the current pulses to the first electrical contacts 85 of said means 80 provided for the localized heating of the portion 81, means 80 which generate an expansion of the gas towards the valley of said portion 81 so as to push and advance the released/desorbed analytes towards the outlet portion 21.

Advantageously, in a different embodiment illustrated in FIG. 7, said means 80 for causing localized heating in correspondence with a portion 81 of the analytical capillary defined upstream of the trapping portion 17 comprise a second configuration 101 in which the first electrically conductive element 70 (i.e. the inlet one)—provided to send the pulsed current to the trapping portion 17 in order to heat it and thus cause the release/desorption of the immobilized analytes in said portion—is associated, preferably by microwelding, with the upstream portion 19 of the said analytical capillary 4 at a certain distance, corresponding to the portion 81, with respect to the beginning 89 of the said trapping portion 17, i.e. with respect to the end where the capillary 4 enters the element 11.

Conveniently, as shown in FIG. 7, the portion 81 between the contact area 74 (of the electrically conductive element 70 with the analytical capillary 4) and the beginning 89 of the trapping portion 17 (corresponding to the entrance of the capillary 4 to the interior of the element 11) is substantially greater than the length of the trapping portion 17 (i.e. the capillary section 4 which is inserted/housed and passes through the element 11 and which is therefore in close contact with the cold group 12).

In this way, therefore, the pulsed current sent, in correspondence with the contact area 74, from the electrically conductive inlet element 70 to the capillary 4, and therefore passing through the trapping portion 17 causes the desorption/release of the analytes which are found in said trapping portion 17; however, in addition to this, the fact that the current is sent to the capillary 4 well before the trapping portion 17 causes localized heating of the aforesaid portion 81, and therefore generates an expansion of the gas along the longitudinal development of the capillary, thus pushing the released analytes to leave the trapping portion and to move towards the outlet portion 21.

Basically, these means 80 configured to cause localized heating—preferably by electric heating—of the portion 81 of the analytical capillary 4, which is provided upstream of the trapping portion 17, generate a particularly rapid expansion of the gas contained in said section. Suitably, this expansion causes a thrust towards the exit of the trapping portion 17 of the analytes which are inside the portion itself and which have been released following the heating of said portion. In particular, this expansion that pushes the analytes out of the trapping portion 17 occurs before the analytes are again immobilized within said portion.

Conveniently, also in this second configuration 101, said means 80 are managed by the control unit of the modulator 2 which appropriately controls their activation and deactivation by sending appropriate current pulses generated by an electronic system, preferably by capacitor charge and discharge. In particular, the control unit controls the transmission to the first electrically conductive element 70 of pulsed current (preferably of substantially square-wave current pulses) of substantially constant intensity, preferably equal to 10-200 A, preferably of 80 A; in particular, suitably, the effective duration of these current pulses is extremely reduced, of the order of 0.1-10 ms, preferably of 0.5 ms; suitably, the frequency of the pulsed current is about 0.03-10 Hz, preferably about 0.1-1 Hz.

Conveniently, it is understood that the same modulator 2 can comprise means 80 implemented only according to the first configuration 100 (see FIGS. 1 and 2), or means 80 implemented only according to the second configuration 101 (see FIG. 8), or again it can comprise means 80 implemented both according to the first 100 and to the second 101 configuration.

Advantageously, in both the configurations 100 and 101, these means 80 cause a “pulse” injection of the analytes in the column of the second dimension.

Advantageously, these means 80 allow to have, for the peak of the sample that is coming out of the trapping portion 17 of the capillary 4 of the modulator 2, a very rapid injection entering the second column, as evaporation (release) of the sample in the trapping portion 17 was rapid. In this way, the peak of the sample at the output of the modulator is extremely narrow and, therefore, given a certain quantity of sample, the height of the peak is extremely high and the signal to noise ratio is significantly improved. This is particularly advantageous since very narrow peaks are ideal to be detected by fast detectors, such as the time-of-flight mass spectrometer and also the flame ionization detector, with acquisition frequencies up to 1000 Hz and beyond.

Conveniently, moreover, these means 80, being upstream with respect to the trapping portion 17, do not contribute to the extension/widening of the band of the second dimension. In particular, the expansion volume determined by these means 80 is so small and the duration of such expansion is so short that they do not cause any extension/widening of the column band. Advantageously, these means 80 can be suitably configured so as to obtain the desired thrust effect on the analytes; for example, to reduce the rise in local temperature in the portion 81, the length of the capillary tract affected by said raising can be increased and the amplitude of the injected current is reduced.

Advantageously, the modulator 2 also comprises a housing structure 50 which is configured to connect the cooling system 8 with the thermostated chamber (oven) 48 of the gas chromatograph 49.

In particular, the structure 50 comprises:
a lower portion 51, preferably of tubular shape, which enters the thermostated chamber of the gas chromatograph and which is traversed by the analytical capillary tube; advantageously, the lower portion 51 is suitably filled with a thermally insulating material,
a central portion 52 inside which a chamber is defined in which the cold zone 10 of the cooling system 8 is housed, the element 11 which supports the analytical capillary 4 and the electrically conductive elements 70 and 71,
an upper portion 53 which is fixed to the body of the cooling system 8.

More in detail, the chamber defined in the central portion 52 is delimited by:
a first upper half-shell 55 in which the cold zone 10 is housed, which is suitably filled with a thermally insulating material 69,
a second lower half-shell 56, which is suitably filled with a thermally insulating material 57, and in which the element 11 is housed; preferably, the thermally insulating material 57 is constituted by a polyurethane foam which is suitably injected inside said lower shell.

Advantageously, the structure 50 is configured so that the central portion 52—which contains the cold zone 10, the element 11 with the analytical capillary 4 and the electrically conductive elements 70 and 71—are arranged externally, even if in close proximity, with respect to the thermostated chamber 48 of the gas chromatograph 49. Advantageously, a through hole is formed on a wall 18 of the thermostated chamber 48 of the gas chromatograph, inside which is inserted the lower portion of the structure 50. Suitably, outside the thermostated chamber 48 of the gas chromatograph 49, a suitable support structure 59 is provided for the body 22 of the cooling system 8.

Conveniently, in an alternative embodiment not shown, the cold zone 10 (or at least its lower surface) of the cooling system 8, the element 11 and the unit which comprises the analytical capillary 4 and the electrically conductive elements 70 and 71 are all inserted and housed inside the thermostated chamber (oven) 48 of the gas chromatograph 49.

More in detail, the gas chromatograph 49 can have a single thermostated chamber 48 which, in addition to housing the aforementioned components of the modulator 2, houses entirely both the gas chromatographic columns 1, 3. Alternatively, the gas chromatograph can comprise, in addition to the thermostated chamber 48 which houses the aforementioned components of the modulator 2, a second thermostated chamber, not shown, which is separated with respect to said first thermostated chamber 48 and is traversed by the first gas chromatographic column 1 or by the second gas chromatographic column 3.

Moreover, at the wall 18 of the thermostated chamber 48 of the gas chromatograph and/or at the housing structure 50, further through holes are also made to allow the passage of the cables. In particular, these holes are necessary to allow the passage of cables (not shown) that connect the electronic system for generating the current with the conductive elements 7 and the electrically conductive elements 70 and 71, with the electrical connections 97, as well as with the means 80 for localized heating of the portion 81.

Conveniently, the control unit is connected to an electric power source (not shown) of the entire modulator 2.

Advantageously, the control unit is connected to the electronic system for charging and discharging capacitors, which is capable of storing a predefined (settable) and high quantity of electrical energy and then releasing it. In particular, the electronic system for charging and discharging with capacitors is controlled by the control unit so as to generate, during the discharge phase, pulsed current signals, which pass through the conducting elements 7 and the electrically conductive elements 70 or 71 so as to cause the trapping portion 17 and the means 80 to heat up for the localized heating of the portion 81.

Advantageously, a computer 40 is connected to the control unit on which a suitable software is installed which acts as an interface for programming and setting the entire modulator 2, as well as for displaying and processing the results.

The operation of the modulator 2 according to the invention is as follows. Once the cooling system 8 has been activated, it will begin to cool until the cold zone 10 reaches a specific cryogenic temperature defined on the basis of the analyte to be analyzed. In particular, it is possible to reach particularly low cryogenic temperatures, down to down to −210° C. depending on the analyte to be analyzed. Once the cryogenic temperature is reached, the cooling system 8 (which preferably includes a Stirling cryocooler) always remains active so as to keep it stable, or to control it according to predefined temperature ramps during the execution of the gas chromatographic analysis.

Conduction cooling, by means of the element 11, of the analytical capillary 4 at the trapping portion 17 allows the analytes passing through said capillary tube section to be immobilized at a cryogenic temperature.

The control unit then controls the sending of appropriate pulsed current signals, which cause the activation, fora well-defined time interval, between 0.1 ms-10 ms, of the electrically conductive elements 70 or 71 so as to cause the trapping portion 17 of the capillary 4 to heat up; in particular, in this way, an increase in the temperature of the trapping portion 17 is obtained, i.e. a passage of the latter from the cryogenic temperature to a heated temperature (substantially corresponding to the boiling point of the analytes to be analyzed), and this causes the desorption of the analytes, which are thus rhythmically released, one by one.

Typically, the aforementioned current pulses, obtained from capacitive discharges, are generated starting from an initial discharge voltage which has been previously set and which is reached, during the charging phase, with voltage values comprised between 10 and 100 Volts. These discharges last for a time between 0.1 and 10 milliseconds in order to allow a ready release of the cryogenically immobilized analytes, as well as to avoid an excessive rise in temperature.

Once the sequence of the current impulse discharges of the capacitors, and therefore the heating of the trapping portion 17 obtained by means of the electrically conductive elements 70 and 71, is terminated, the temperature of said portion 17 returns rapidly to the cryogenic temperature thanks to the cooling by conduction that the cold group 12 operates on said portion 17 of the capillary 4.

As mentioned, advantageously, the cooling system 8, which comprises—preferably—the Stirling cryocooler 8, allows a rapid cryofocalization/immobilization of the analytes at very low temperatures, down to −210° C. according to the analyte to be analyzed. Moreover, in order to prevent the analytes from becoming immobilized again (re-crystallization) before leaving the trapping portion 17, their exit is favored by the expansion of the gas, and by the consequent thrust generated by the means 80 for localized heating of the portion 81 of capillary 4 which is located upstream of said trapping portion 17.

Advantageously, during the gas chromatographic analysis, in order to optimize the performance of the analysis itself, the control unit conveniently controls the variation, according to pre-set ramps, of the discharge potentials and/or of the modulation time (i.e. the time between the start of a discharge and the next one) and/or the desorption time (also called “duty cycle”, that is the fraction of the modulation time during which current is sent to the electrically conductive elements associated with the analytical capillary).

From the aforegoing it is apparent that the modulator according to the invention is much more advantageous with respect to the traditional ones in that:
the immobilization temperatures of the analytes can be varied in a particularly wide range and this is achieved by controlling the temperatures of the cold zone of the cooling system (Stirling reverse cycle cryocooler and/or Peltier cells) with feedback,
the analyte release temperatures can be varied over a particularly wide range and this is achieved by correspondingly controlling the duration and/or amplitude of the current sent to the heating means acting on the capillary,
the chromatographic resolution in the first and second dimensions is particularly high thanks to a direct fluid-dynamic connection of the input and output of the modulator with the respective gas chromatographic columns,
the release rate of the analytes is extremely high; this derives from an extremely rapid heating of the trapping portion of the analytes and, in particular, is obtained through the direct connection between the analytical capillary and the capillary portion which defines the heating means, as well as thanks to the fact that to said portion of the heating capillary a particularly high current is sent for extremely short periods of time,
the immobilization rate of the analytes is extremely rapid (i.e. it is about 1-2 ms); this is obtained with an extremely rapid cooling which derives from the fact that the analytical capillary, through the housing element, is in direct contact with the cold zone of the cooling system.

Furthermore, the modulator according to the invention is particularly advantageous in that:
does not use nitrogen or other gases,
does not cause any disturbance of the internal state of the internal chamber of the gas chromatograph,
by using a reverse Stirling cycle cryocooler with its cold contact with the analytical capillary part, by interposing a support element, a greater cooling capacity is obtained; in particular, it allows to reach particularly low cryogenic temperatures of about −210° C., while the traditional ones with nitrogen cooling do not allow temperatures below −196° C. to be reached; moreover, once the heating is finished, it allows a particularly rapid, substantially instantaneous return to trapping conditions (i.e. the passage from the heating temperature to the cryogenic temperature);
allows the cooling temperature to be set, depending on the analytical needs, to different values substantially included in the temperature range between −210° C. and 30° C.,
during the gas chromatographic analysis, it is possible to control and modify both the modulation time, that is the time that elapses between the start of a discharge and the next one, and the “duty cycle” of the modulation, i.e. that fraction of the modulation time during which current is sent to the electrically conductive elements,
is particularly flexible, i.e. it can be used substantially with any type of detector.

The invention claimed is:

1.-46. (canceled)

47. A thermal modulator for gas chromatography comprising:
an analytical capillary for crossing analytes and adapted to be interposed between two gas chromatographic columns;
a cooling system comprising a cold zone;
a support element associated with the cold zone and configured to support a first portion of the analytical capillary so that the first portion is at a same or than the cold zone, the first portion passing through or is in contact with the support element defining a trapping portion in which the analytes passing through the analytical capillary are to be trapped or immobilized;
a control system that selectively controls a sending of pulsed current to electrically conductive elements associated with the analytical capillary, so as to heat the trapping portion and cause a release or desorption of previously immobilized analytes; and
a heating system that causes a heating of a second portion of the analytical capillary positioned outside of the support element and upstream of the first portion of the analytical capillary, so as to generate a rapid expansion of a gas, contained in the second portion, along a direction of development of the analytical capillary and facilitate an advancement of the analytes released or desorbed towards an outlet of the first portion.

48. The thermal modulator according to claim 47, wherein the cooling system comprises a reverse Stirling cycle cryocooler.

49. The thermal modulator according to claim 47, wherein the cold zone of the cooling system and/or the support element are wound, at least in part, with thermally insulating materials.

50. The thermal modulator according to claim 47, wherein the support element is made of a thermally conductive material and is electrically isolated at least on a surface of the support element.

51. The thermal modulator according to claim 50, wherein the support element has a geometrical conformation defining a heat exchange interface between the cold zone of the cooling system and the trapping portion of the analytical capillary.

52. The thermal modulator according to claim 47, wherein the electrically conductive elements comprise:
a first electrically conductive element for current input, the first electrically conductive element being in contact with the analytical capillary at a first contact area located upstream or downstream, of the trapping portion, which passes through or is in contact with the support element; and
a second electrically conductive element for current output, the second electrically conductive element being in contact with the analytical capillary at a second contact area located downstream or upstream of the trapping portion which passes through or is in contact with the support element.

53. The thermal modulator according to claim 52, wherein the electrically conductive elements comprise a third portion of the analytical capillary that is made of an electrically conductive material and which is interposed between the first electrically conductive element and the second electrically conductive element, the trapping portion, passing through or being in contact with the support element, being defined at least in part by an analytical capillary section interposed between the first electrically conductive element and the second electrically conductive element.

54. The thermal modulator according to claim 52, wherein the electrically conductive elements comprise at least two electrically conductive elements associated with corresponding portions of the analytical capillary, which are external to the support element and which are positioned upstream and downstream, respectively, with respect to the first portion of the analytical capillary which passes through or is in contact with the support element.

55. The thermal modulator according to claim 52, wherein the electrically conductive elements comprise metal capillaries of a same type as the analytical capillary.

56. The thermal modulator according to claim 55, wherein the first electrically conductive element for the current input and/or the second electrically conductive element for the current output comprise thread-shaped elements made from a conductive material, which are welded at contact areas defined respectively in an inlet section and in an outlet section of the first portion of the analytical capillary which passes through or is in contact with the support element.

57. The thermal modulator according to claim 52, wherein the pulsed current sent to the electrically conductive elements to cause the release or the desorption of the previously immobilized analytes has an amplitude of 10-200 A and/or a duration of 0.1-10 ms.

58. The thermal modulator according to claim 52, wherein the electrically conductive elements are connected to a current source to heat in a continuous manner the first portion of the analytical capillary, which passes through or is in contact with the support element, thus regulating a temperature at which the analytes are trapped or immobilized.

59. The thermal modulator according to claim 58, wherein the current source provides a continuous current of 0.1-3 A or is an alternating current of a frequency greater than 5 Hz.

60. The thermal modulator according to claim 52, wherein the heating system is configured to send a pulse current to the second portion.

61. The thermal modulator according to claim 60, wherein the heating system has a configuration, in which the analytical capillary is folded to define at least one winding, to which first electrical contacts are associated, for an input of the pulsed current which causes a heating of the winding, and second electrical contacts for an output of the current, or vice versa.

62. The thermal modulator according to claim 60, wherein the heating system for heating the second portion, which is positioned outside of the support element and upstream of the first portion of the analytical capillary, which crosses or is in contact with the support element, has a configuration, in which the analytical capillary defines a rectilinear segment, to which first electrical contacts are associated, for an input of the pulsed current, which causes a heating of the rectilinear segment, and second electrical contacts for an output of the current, or vice versa.

63. The thermal modulator according to claim 60, wherein the pulsed current is sent to electrical contacts of the heating system and the second portion of the analytical capillary, and comprises square wave pulses of constant intensity and effective duration of 0.1-10 ms.

64. The thermal modulator according to claim 60, wherein the control system is configured so that the pulsed current, send to the electrically conductive elements for heating the trapping portion and cause the release or the desorption of the immobilized analytes, is carried out simultaneously or is delayed with respect to sending current pulses to the electrical contacts of the heating system provided for a localized heating of the second portion of the analytical capillary.

65. The thermal modulator according to claim 52, wherein the heating system for heating the second portion of the analytical capillary, which is positioned outside of the support element and upstream of the first portion of the capillary, which crosses or is in contact with the support element, has a configuration, in which the first electrically conductive element, provided for sending to the trapping portion of the analytical capillary a current suitable for causing a heating of the trapping portion adapted to release or desorb the analytes immobilized in the trapping portion, is associated with the analytical capillary at a contact area, which is spaced with respect to an inlet or beginning of the first portion.

66. The thermal modulator according to claim 52, wherein the second portion between the contact area and an inlet or beginning of the first portion is greater than a length of the first portion.
